(19) United States
(12) Patent Application Publication
(10) Pub. No.: US 2005/0235923 A1
(43) Pub. Date: Oct. 27, 2005

(54) Changeable-floor type rearing cage

(76) Inventor: Motohiro Niki, Tokyo-To (JP)

Correspondence Address: LADAS & PARRY, 26 WEST 61ST STREET, NEW YORK, NY, 10023, US

(21) Appl. No.: 11/102,287

(22) Filed: Apr. 8, 2005

Related U.S. Application Data
(63) Continuation-in-part of application No. 10/247,535, filed on Sep. 19, 2002, now abandoned.

(30) Foreign Application Priority Data
Sep. 25, 2001 (JP) 2001-291527

(51) Int. Cl. A01K 1/01

(52) U.S. Cl. 119/479

(57) ABSTRACT

A changeable-floor type rearing cage for rearing small animals includes a hexahedral cage body having a top wall, four side walls and a bottom wall, and defining a space for rearing small animals therein. Upper and lower floor boards are inserted into the cage body through respective slots at the bottom of the front side wall. The upper and lower floor boards are independently removed from the cage body for cleaning. The animal is normally supported by the upper floor body except during cleaning when it is removed and then the animal is supported by the lower floor board. The upper floor board is perforated and the lower floor board is solid.

### CROSS RELATED APPLICATION

This application is a continuation-in-part of application of Ser. No. 10/247,535 filed Sep. 19, 2002 claiming the priority of Japanese Application 2001-291,527 filed Sep. 25, 2001.

### BACKGROUND OF THE INVENTION

1. Field of the Invention

The present invention relates to a rearing cage for rearing small animals, such as rats and mice, for experiments.

2. Description of the Related Art

A rearing cage for rearing small animals for experiments has is placed on one of a plurality of shelves of a rack. Small animals are kept in the rearing cage placed on the shelf. A conventional rearing cage is a hexahedral wire net cage having a top wall, four side walls and a bottom wall. The bottom wall is a net having meshes that permit solid excrements excreted by small animals kept in the rearing cage to fall onto a drawer-type tray disposed under the bottom wall. If the bottom wall is not provided with any meshes, excrements accumulate on the bottom wall in heaps of excrements. Therefore, it is absolutely essential to provide the bottom wall with meshes to drop excrements through the bottom wall, which is a common knowledge in the relevant industry. In a netted, hexahedral rearing cage having a wire net bottom wall provided with meshes, any bedding is not spread on the bottom wall. Bedding is formed of wood chips, sawdust, wood shavings or pulp chips. The size of the meshes of the bottom wall is, for Example, 6 mm-10 mm square.

There has recently been used a plastic rearing cage consisting of a plastic cage body having one bottom wall, four side walls, and an open top, and a wire net lid put on the cage body to cover the open top. The bottom wall of the plastic rearing cage is a smooth panel not having any meshes. Bedding, such as sawdust, is spread on the bottom wall of the plastic rearing cage. Since the plastic cage body has the open top, the atmosphere in the plastic cage body is kept clean by forced ventilation using an air-conditioning device.

Since the bottom wall of the hexahedral wire net rearing cage has meshes, the paws and feet of animals kept in the rearing cage are rubbed by the wires forming the meshes and, consequently, tumors and corns are liable to be formed in the paws and the soles of the feet of the animals and the animals often suffer from arthritis. More over, muck sticks to the joint of the wires. Muck stuck to the wires makes the rearing cage unsanitary, and requires troublesome work including immersing the wire net bottom in water for a whole day and night, and brushing the wire net bottom in hot water to remove the muck. The meshes in the wire net bottom give a feeling of wrongness to the animals kept in the rearing cage, which affects adversely to the mental stability of the animals. Even if bedding is spread on the wire net bottom, the bedding drops through the meshes and hence there has been no idea of spreading bedding on the wire net bottom of a rearing cage.

Bedding can be spread on the bottom of the plastic rearing cage. The plastic rearing cage is free from the problems in the hexahedral wire net rearing cage. The atmosphere in the plastic rearing cage can be cleaned by an air-conditioning device to avoid infecting people with diseases of animals. Since the interior of the plastic rearing cage isolated from the exterior is easily polluted, the plastic rearing cage must be ventilated such that the air in the plastic rearing cage is changed two hundred times or above every hour to prevent the long stagnation of ammonia, chemical substances contained in animal foods and viruses provided by the animals kept in the plastic rearing cage. The ventilation of the plastic rearing cage consumes much energy, high wind pressure necessary for ventilation affect the propagation of the animals adversely, the animals are liable to catch cold, the animals have difficulty in recovering from pneumonia and the consumption of animal foods increases. Since the side walls and the bottom wall of the plastic rearing cage have the shape of flat plates, a fixed air currents are formed in the plastic rearing cage, dead spaces where air currents stagnate are formed in the plastic rearing cage, and air flows in eddies along the flat walls. Therefore, it takes one or more hours to change the entire air in the plastic rearing cage.

### SUMMARY OF THE INVENTION

The present invention has been made to solve those problems in the prior art and it is therefore an object of the present invention to provide a changeable-floor type rearing cage, for rearing small animals, that does not form tumors and corns in the paws and the soles of the feet of the small animals, does not make the small animals suffer from arthritis, does not give the small animals a feeling of wrongness, is capable of preventing muck from firmly sticking thereto and making the removal thereof difficult, has a floor that can be easily cleaned, and does not consume much energy for ventilation.

According to the present invention, a changeable-floor type rearing cage includes a hexahedral cage body having a top wall, four side walls and a bottom wall, and defining a space for rearing small animals therein, and a drawer-type floor board placed in the cage body so as to be drawn out of the cage body, and providing a surface with which the small animals come into contact.

In a typical example of the rearing cage, the bottom wall is formed by arranging only crossbars, and the floor board is supported on the crossbars.

At least part of the floor board may be perforated or meshed.

The floor board may consist of an upper plate and a lower plate, and the upper plate may be perforated.

The drawer-type floor board placed on the bottom wall of the cage body can be easily cleaned. Bedding can be spread on the floor board, and the beddings can be easily replaced with new one. The use of the floor board in combination with bedding is able to protect the paws and soles of feed of the small animals.

### BRIEF DESCRIPTION OF THE DRAWINGS

The above and other objects, features and advantages of the present invention will become more apparent from the following description taken in connection with the accompanying drawings, in which:

FIG. 1 is an exploded perspective view of a changeable-floor type rearing cage in a first embodiment according to the present invention for rearing small animals;

FIG. 2 is a perspective view of the changeable-floor type rearing cage shown in FIG. 1;

FIG. 3 is a perspective view of a floor board that can be used in the changeable-floor rearing cage shown in FIG. 1;

FIG. 4 is a perspective view of another floor board that can be used in the changeable-floor rearing cage shown in FIG. 1;

FIG. 5 is a perspective view of a third floor board that can be used in the changeable-floor rearing cage shown in FIG. 1;

FIG. 6 is an exploded perspective view of a changeable-floor type rearing cage in a second embodiment according to the present invention; and

FIG. 7 is a perspective view of the changeable-floor type rearing cage shown in FIG. 6.

FIG. 8 is a perspective view of a further floor board according to the invention.

FIG. 9 shows the floorboard of FIG. 8 in association with the changeable-floor type rearing cage of FIG. 7.

### DESCRIPTION OF THE PREFERRED EMBODIMENTS

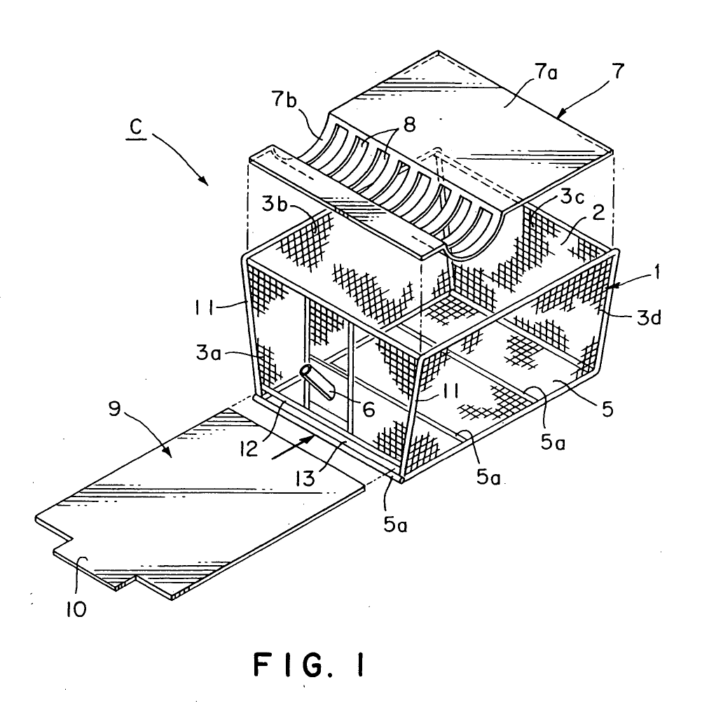

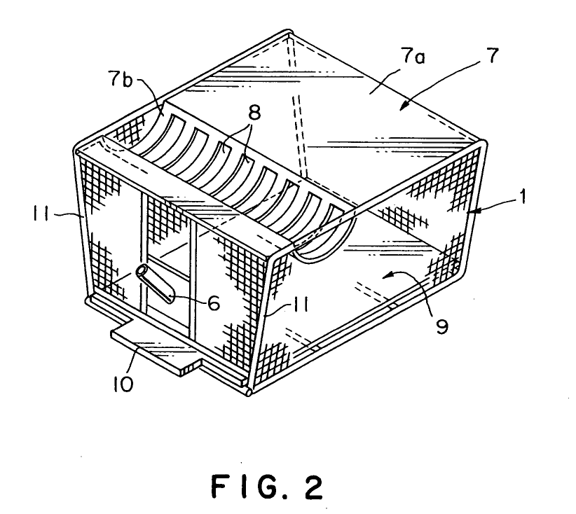

Referring to FIGS. 1 and 2, a changeable-floor type rearing cage C (hereinafter referred to simply as “rearing cage C”) in a first embodiment according to the present invention has a hexahedral cage body 1 having a frame defining a top wall 2, four side walls 3a, 3b, 3c and 3d, and a bottom wall 5, and defining a space for rearing small animals. The four side walls 3a, 3b, 3c and 3d are wire net walls that allow air to flow through the cage body 1. The bottom wall 5 is formed by extending crossbars Sa between the lower sides of the opposite side walls 3b and 3d. The cross bars 5a may be extended between the lower sides of the opposite side walls 3a and 3c. The cage body 1 has an open top 2. A lid 7 is detachably put on the cage body 1 to cover the open top 2. The lid 7 has an impermeable flat part 7a, and a concavely curved feed part 7b provided with a plurality of slots 8. Animal foods are placed on the feed part 7b, and small animals kept in the cage body 1 eat the animal foods through the slots 8. The flat part 7a may be formed of a permeable wire net. In FIGS. 1 and 2, indicated at 6 is a water supply device.

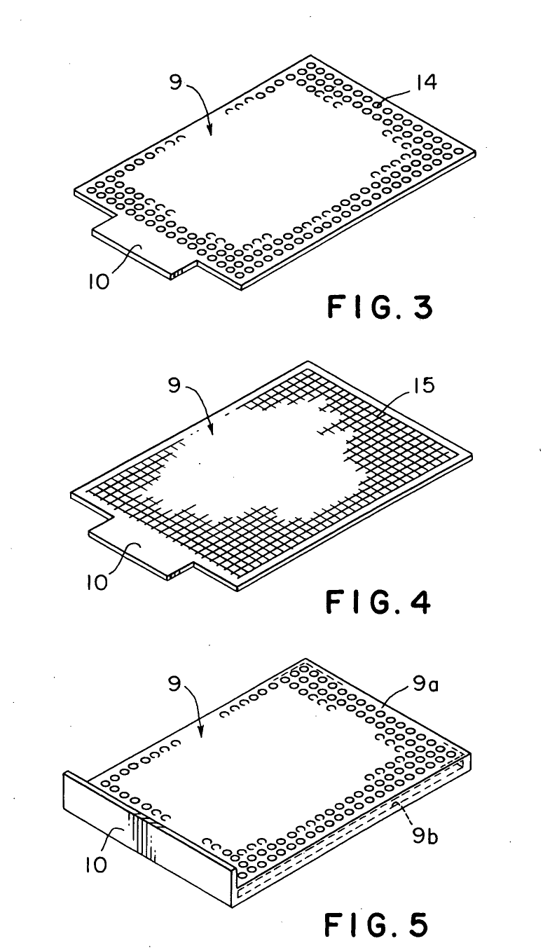

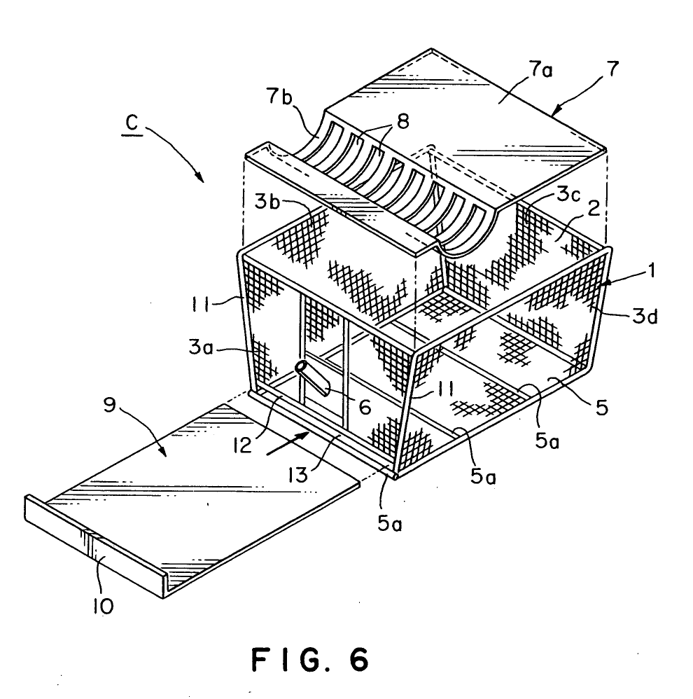

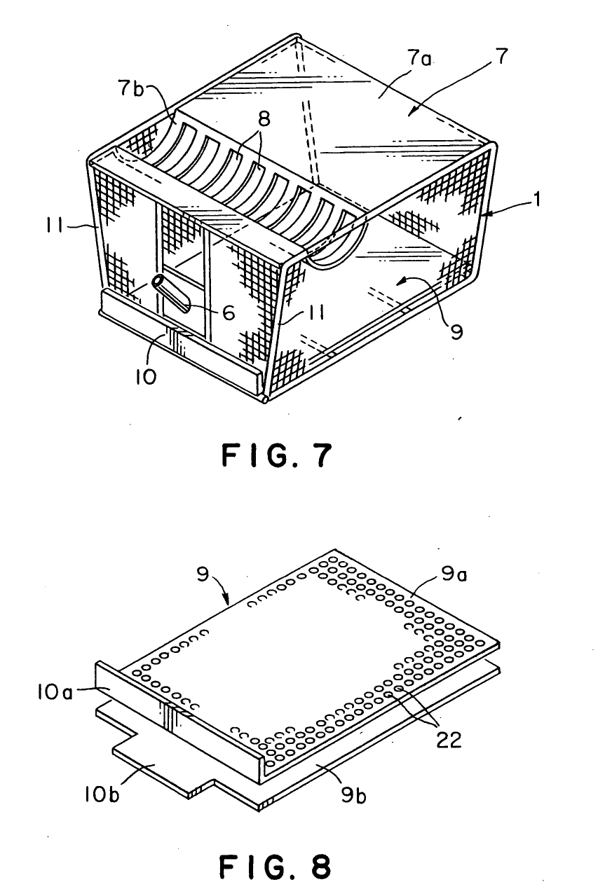

A floor board 9 is placed on the bottom wall 5 of the cage body 1 so as to be drawn out of the cage body 1. The small animals move on the floor board 9. Typically, the floor board 9 is a flat plate not provided with any holes, and is provided with a pull tab 10a on its front side. The floor board 9 is placed on the crossbars 5a forming the bottom wall 5 of the cage body 1. A bar 12 extends between lower parts of frame members 11 forming the front side wall 3a. The bar 12 is at a level slightly above that of the front crossbar 5a of the bottom wall 5 of the cage body 1 to define a slot 13 through which the floor board 9 is inserted in the cage body 1. The floor board 9 is inserted through the slot 13 in the cage body 1 so as to lie on the crossbars 5a of the bottom wall 5 at a predetermined position in the cage body 1. When the floor board 9 is thus positioned, the back end of the floor board 9 is in contact with the back side wall 3c of the cage body 1. A floor board 9 as shown in FIGS. 3-5 and 8 may be employed. The floor board 9 shown in FIGS. 5-8 is provided with a standing stop plate 10b. When the floor board 9 is inserted into the cage body 1, the stop plate 10b comes into contact with the bar 12 to position the floor board 9 at a predetermined position in the cage body 1. The standing stop plate 10b serves as means for preventing the small animals from escaping from the rearing cage C through the slot 13.

The floor board 9 may have a perforated part 14 as shown in FIG. 3 or a mesh part 15 as shown in FIG. 4. When the floor board has the perforated part 14 or the mesh part 15, solid excrements excreted by the small animals can be kept on the floor board 9 and liquid muck, such as urine, can drip through the perforated part 14 or the mesh part 15. When the floor board 9 having the perforated part 14 or the mesh part 15 is employed, a tray for receiving muck and excrements is placed under the cage body 1.

Usually, bedding is spread on the floor board 9. The bedding is formed of wood chips, sawdust, wood shavings or pulp chips. Recently developed bedding formed of synthetic chips having improved water-absorbing property and water-repellent property is capable of being mingled with muck to prevent the surface of the floor board 9 from being polluted with the muck, so that sanitary animal-rearing management can be achieved. Since the rearing cage C has the wire net side walls 3a, 3b, 3c and 3d, the interior of the rearing cage C can be maintained in a properly dry state and the rearing cage C can be properly ventilated. Thus, ammonia and such produced from the muck absorbed by the bedding can flow out of the rearing cage C and hence the interior of the rearing cage C can be maintained in a satisfactorily sanitary state.

Since the floor board 9 is covered with the bedding, tumors and corns are not formed in the paws and the soles of the feet of the small animals, and the small animals do not suffer from arthritis. The size of the chips forming the bedding may be slightly greater than that of the holes of the perforated part 14 or the mesh size of the mesh part 15. The bedding of chips of such a size is able to remain on the floor board 9, enables air to flow through the floor board 9, maintains the interior of the cage C in a sanitary state, and physically protects the soles of the feet of the small animals. The floor board 9 having the perforated part 14 or the mesh part 15 may be, for example, a punched metal sheet.

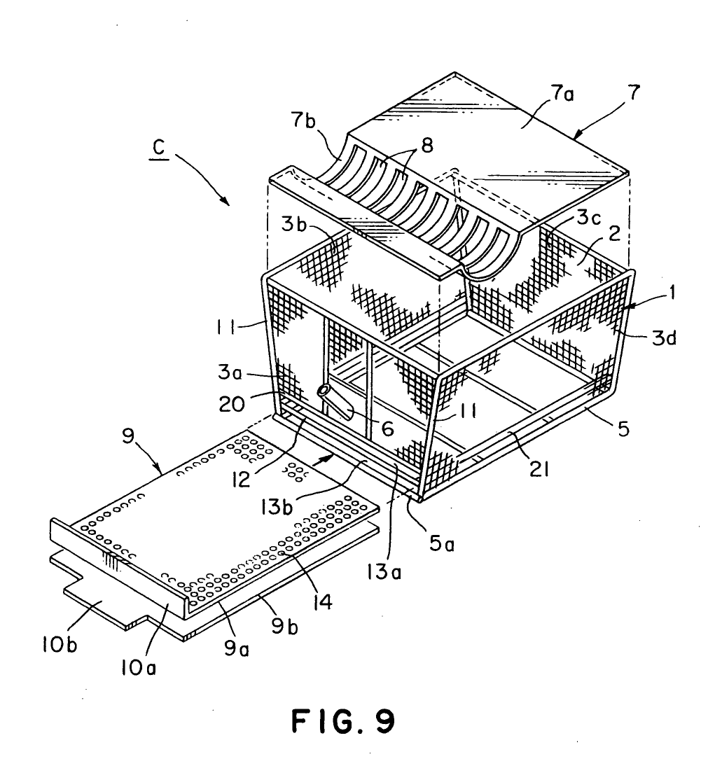

The floor board 9 may consist of an upper plate 9a and a lower plate 9b as shown in FIGS. 5 and 8. The lower plate 9b is formed as a tray for receiving liquid muck. Although the double-wall floor board 9 shown in FIGS. 9 and 8 is provided with the standing stop plate 10, the double-wall floor board 9 may be provided with a pull tab 10 as shown in FIG. 3.

Functions of the changeable-floor type rearing cage C of the present invention will be described hereinafter. The rearing cage C is place on one of a plurality of shelves of a rack, and small animals are kept in the rearing cage C. The lid 7 is removed to put the small animals into and to take the same out of the rearing cage C. In a normal rearing state, the floor board 9 is kept in place in the rearing cage C, and the small animals living in the rearing cage C stay on the floor board 9. Since the rearing cage C has the wire net side walls 3a, 3b, 3c and 3d, the interior of the rearing cage C can be maintained in a properly dry state and the rearing cage C can be properly ventilated.

Since the small animals stay directly on or through the bedding on the floor board 9, solid and liquid muck accumulates on the floor board 9. Since the recently developed, improved bedding is capable of being mingled with the muck to prevent the surface of the floor board 9 from being polluted with the muck, so that sanitary animal-rearing management can be achieved. Since the rearing cage C has the wire net side walls 3a, 3b, 3c and 3d, the interior of the rearing cage C can be maintained in a properly dry state and the rearing cage C can be properly ventilated. Whereas a conventional rearing cage requires changing the bedding every three or four days, the bedding of the rearing cage C of the present invention needs to be changed only every ten to fourteen days.

After the bedding has been polluted to some extent, the small animals are removed from the rearing cage C, the floor board 9 is pulled out of the rearing cage C, and the floor board 9 is sterilized in an autoclave. The sterilized floor board 9 is returned into the rearing cage C or the polluted floor board 9 is replaced with a new one to provide a sanitary rearing environment. The polluted floor board 9 can be easily replaced with a new one simply by pulling out the polluted floor board 9 from the rearing cage C and inserting a clean floor board into the rearing cage C. Satisfactorily sanitary rearing can be achieved by cleaning the cage body 1, for example, once a month and changing the floor board 9 once a week. Even if any bedding is not used and the small animals are kept directly on the floor board 9, a sanitary rearing environment can be maintained by changing the floor board 9 once a week if the small animals need to be kept for a short term.

Although all the side walls 3a, 3b, 3c and 3d of the cage body 1 of the rearing cage C in the foregoing embodiment are highly air-permeable nets, at least one of the side walls 3a, 3b, 3c and 3b may be a net and the rest may be scarcely or only slightly air-permeable plates. The side walls 3a, 3b, 3c and 3d may be poorly air-permeable plates, provided that those air-permeable plates are more permeable to air than the walls of the plastic rearing cage. Although the ability of such poorly air-permeable side walls to maintain a satisfactory rearing environment is somewhat unsatisfactory, there is no practical problem in such side walls.

The bottom wall 5 may be a perforated plate. When the floor board 9 is an air-permeable floor board like that shown in FIGS. 3 or 4, the bedding needs to be changed only once a week. Even if the floor board 9 is provided with holes or gaps for air passage, the bedding is able to compensate for the adverse effect of the holes or gaps. Holes or gaps formed in the floor board 9 permit liquid muck to drip to keep the interior of the rearing cage C clean.

When the floor board 9 consisting of the upper plate 9a provided with holes or a mesh, and the lower plate 9b formed is formed as a tray for receiving muck is used, liquid muck does not stay on the upper plate 9a and the surface of the upper plate 9a remains clean, and no additional liquid muck tray needs to be placed under the rearing cage C.

If the components of the cage body 1 are formed of a stainless steel, the working life of the rearing cage C is practically permanent, and the rearing cage C is excellently sanitary. If the floor board 9 is provided with a slightly depressed part, liquid muck produced by the small animals can be easily collected therein, and most of the floor board 9 can be easily kept dry.

The floor board 9 may be a flat plate, may have the perforated part 14 or the mesh part 15, and the openings of the perforated part 14 or the mesh of the mesh part 15 may be formed in a proper size according to the purpose of the floor board 9 to use the rearing cage C for rearing small animals for various tests, such as a metabolic test, a breeding test, an individual feeding test, a group feeding test, a bird-rearing test and a quarantine test.

As apparent from the foregoing description, the drawer type floor board placed on the bottom wall of the cage body can be easily cleaned and facilitates changing the beddings spread on the floor board. The bedding spread on the floor board protects the paws and the soles of the feed of the small animals kept in the rearing cage, does not form tumors and corns on the paws and the soles of the feet of the small animals, does not make the small animals suffer from arthritis and from a feeling of uneasiness, is capable of preventing muck from firmly sticking to the cage body and making the removal thereof difficult, facilitates cleaning work, and does not consume much energy for ventilation.

Even though the bottom wall of the cage body is formed only of the crossbars, any problem arises in rearing the small animals because the floor board is placed on the crossbars. The bottom wall of the cage body can be easily formed by extending the crossbars longitudinally or laterally in a horizontal plane.

Since the floor board has the perforated or meshed part, liquid muck can drip through the perforated or meshed part, so that the surface of the floor board can be kept dry.

When the floor board consisting of the perforated upper plate and the tray-shaped lower plate is used, liquid muck is able to drip through the holes formed in the upper plate onto the lower plate and can be collected in the lower plate, which facilitate the sanitary management of the rearing cage. The standing stop plate prevents the small animals from escaping through the slot in the cage body.

In FIG. 8, the floor board 9 is composed of the upper floor board 9a and the lower floor board 9b. In FIG. 9, the cage C is formed with an upper slot 13a and a lower slot 13b. The upper slot 13a is formed between the bar 12 and a bar 20 and the lower slot 13b is formed between the cross bar 5a and the bar 12.

The upper floor board 9a is inserted through the upper slot 13a and is guided by guides 21 disposed on the side walls. The lower floor board 9b is inserted through the lower slot 13b and rides on the crossbars 5a. The upper floor board 9a and the lower floor board 9b can be independently inserted through the slots 13a, 13b.

The upper floor board 9a is perforated and has openings 22. The size of the openings 22 is set so that solid excrement excreted by the small animals can be kept on the upper floo9r board 9a and the liquid muck, such as urine, can drip through the openings 22.

The size of an opening 22 is not greater than the distance between the neighboring opening 22. For example, the size of the opening 22 can be about 4 mm in diameter and the distance between the neighboring opening 22 can be about 6 mm.

In another case, it is possible for the size of the openings 22 to be very small so that liquid muck excreted by the small animals can be retained and absorbed by the bedding on the upper floor board 9a and only air can pass through the openings 22. In this case, both solid muck and liquid muck are kept on the upper floor board 9a and the rearing cage C is properly ventilated through the openings 22. The size of the opening 22 in this case is not greater than 1 mm in diameter and, for example, is 0.5 mm in diameter.

The upper floor board 9a is provided with a standing stop plate 10a. The upper floor board 9a is flat except for the standing stop plate 10a. The standing stop plate 10a serves as means for preventing a small animal, such as a rat, from escaping from the rearing cage C through the upper slot 13a. The standing stop plate 10a can further serve as a means for retaining solid muck on the upper floor board 9a, and the solid muck on the upper floor board 9a is removed when the upper floor board 9a is drawn out through the slot 13a.

The bedding is placed on the upper floor board 9a.

The bottom wall 5 is formed by arranging only crossbars 5a serving as strengthening members.

The lower floor board 9b is a flat plate not provided with any holes, it has a pull tab 10b at its front edge.

The upper floor bard 9a and the lower floor board 9b function as follows.

When the upper floor board 9a and the lower floor board 9b are within the rearing cage C, solid muck is accumulated on the upper floor board 9a and a part of the liquid muck is absorbed by the bedding on the upper floor board 9a and the remaining part of the liquid muck passes through the perforations 14 in the upper floor board 9a and is received on the lower floor board.

When the rearing cage C is to be cleaned, the lower floor board 9b is drawn out and cleaned while the upper floor board 9a remains, and the cleaned lower floor board 9b re-inserted through the lower slot 13b. Next, the upper floor board 9a is drawn out while the lower floor board 9b remains in place and the small animal is now supported on the cleaned lower floor board 9b. The upper floor board 9a is cleaned by removing solid muck therefrom and the old bedding is removed and replaced by new bedding.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. A changeable-floor type rearing cage for rearing small animals, comprising:
a hexahedral cage body having a top wall, four side walls and a bottom wall, and defining a space for rearing small animals therein; and
a drawer-type floor board placed in the cage body so as to be drawn out of the cage body, and
wherein said drawer-type floor board comprises an upper floor board and a lower floor board,
said upper floor board being perforated and the lower floor board comprising a flat board with no openings,
the upper floor board and the lower floor board being mounted in the cage body for being separately and independently removable therefrom.

2. The changeable-floor type rearing cage according to claim 1, wherein said perforated upper floor board has openings of a size so that solid excrement excreted by the small animal can be retained on the upper floor board and liquid muck including urine, can drip through the openings.

3. The changeable-floor type rearing cage according to claim 2, wherein the size of the openings in the upper floor board is such that at least some liquid muck can be retained on the upper floor board and air can pass through said openings.

4. The changeable-floor type rearing cage according to claim 2, wherein said openings in said upper floorboard are of a size so that both solid excrement and liquid muck excreted by the small animal can be retained on the upper floor board and air can pass through said openings.

5. The changeable-floor type rearing cage according to claim 1, wherein the upper floor board provides a support surface between the perforations which the small animal comes directly into contact therewith.

6. The changeable-floor type rearing cage according to claim 1, wherein said bottom wall is formed only by crossbars serving as strengthening members, the lower floor board being placed on said crossbars for support thereby.

7. The changeable-floor type rearing cage according to claim 1, comprising a bedding spread on the upper floor board.

8. The changeable-floor type rearing cage according to claim 1, wherein one of said sidewalls is a front wall having respective slots through which the upper and lower floor boards can be respectively inserted into and removed from the cage body.

9. The changeable-floor type rearing cage according to claim 1, wherein the perforated upper floor board is provided with perforations of a size relative to said small animal for passing liquid produced by the animal through the upper floor board while retaining solids excreted by the small animal, said perforations being regularly spaced in said upper floor board to provide flat surfaces of said upper floor board between adjacent perforations for support of feet of said small animals.

11. The changeable-floor type rearing cage according to claim 10, wherein the size of said perforations is less than a spacing between adjacent perforations.

12. The changeable-floor type rearing cage according to claim 10, wherein said perforations are in the form of circular holes.

13. The changeable-floor type rearing cage according to claim 12, wherein said flat plate is a metal sheet and said holes are punched in said sheet.

14. The changeable-floor type rearing cage according to claim 7, wherein said bedding comprises chips of material adapted for being supported on said upper floor board.
